(19) United States
(12) Patent Application Publication
(10) Pub. No.: US 2022/0246920 A1
(43) Pub. Date: Aug. 4, 2022

(54) ANODE FOR ZN-BASED BATTERIES

(71) Applicant: Hunt Energy Enterprises, L.L.C., Dallas, TX (US)

(72) Inventors: Jin-Myoung Lim, Coppell, TX (US); Fantai Kong, McKinney, TX (US)

(21) Appl. No.: 17/589,658

(22) Filed: Jan. 31, 2022

Related U.S. Application Data
(60) Provisional application No. 63/143,570, filed on Jan. 29, 2021.

(51) Int. Cl. H01M 4/36; H01M 4/134; H01M 4/1395; H01M 4/42; H01M 10/36

(52) U.S. Cl. CPC H01M 4/366; H01M 4/134; H01M 2004/027; H01M 4/42; H01M 10/36; H01M 4/1395

(57) ABSTRACT

A composite anode for a zinc-based battery device is disclosed. The composite anode includes a pretreated Zn layer with one or more first coating layers, where in the Zn layer comprises a Zn film and a pretreated current collector substrate with one or more substrate coating layers. The pretreated Zn layer is pretreated by one or more of polishing, grinding, sanding, etching, and cleaning and the pretreated current collector substrate is pretreated by one or more of polishing, grinding, sanding, etching, and cleaning.

### CROSS-REFERENCE TO RELATED APPLICATIONS

This application claims priority to U.S. Provisional Application No. 63/143,570 filed Jan. 29, 2021, entitled Anode for Zn-Based Batteries by Jin-Myoung Lim and Fantai Kong, the contents of which are hereby incorporated by reference.

### TECHNICAL FIELD

This invention relates to energy storage devices and electrical storage in general.

### BACKGROUND

Renewable energy sources such as wind and solar are becoming much more prevalent in the supply of electrical power to transmission grids. Their variable nature has created electrical transmission grid management problems and crippling downward pricing pressure on renewable power generators. Large scale storage is a potential solution to these problems, but the scale and attendant costs are enormous. As an example, in a single hour, one wind turbine can fully charge ten of the largest capacity electric automobile battery piles available today. These piles represent over ten tons of highly engineered and expensive materials for merely one hour of electric service.

This disclosure relates to various anodes comprising carbonaceous composites, coatings, alloys, polymers, metal powders, electrode additives and electrolyte additives, and methods for producing them. This relates to energy storage devices based on Zn ion systems in general.

The ever-growing markets of electric vehicles, portable electronics, and grid energy storage escalate the demand for safe and renewable energy storage systems with high energy and longer cycle life. Aqueous Zn-based batteries have been recognized as a promising candidate due to their intrinsic safety. The appeal of Zn anodes is owed to its high theoretical capacity (820 mAh/g), low redox potential (−0.762 V vs. SHE), cost effectiveness, and environmental friendliness. Some Zn batteries have been developed by altering the electrochemical properties of cathode materials.

However, this development has been hampered by the Zn metal anode suffering from uncontrollable dendrite growth and dead Zn generation. The dendrite growth can penetrate the separator and lead to a short circuit, and the dead Zn blocks an electron pathway and diminishes the capacity. Various strategies have been investigated to overcome these challenges such as structural design, coating, and electrolyte additives, but their practical application and commercialization have not yet been viable. Another key challenge is corrosion, dissolution, passivation, and degradation of the Zn anode in water-based electrolytes. Zn anodes dissolve in an acidic electrolyte with a pH less than 6.5, and they are also highly unstable at temperatures higher than 40 degrees C. While the Zn anode is dissolving in water, pH increase is an inevitable behavior that generates an oxide passivation layer on the Zn anode, resulting in its transformation to an inactive state. During this process, the anode keeps generating H2 gas which accelerates corrosion of adjacent metal components. During the electrochemical reactions, galvanic corrosion is severe on the metal substrate attached to the Zn anode. For this reason, it is crucial to develop an anode that has suppressed Zn dendrite growth and dead Zn particle generation as well as minimized corrosion, dissolution, passivation, and degradation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustration of an exemplary Zn film 110 with one or more layers of coating 120.

FIG. 2 is a schematic illustration of an exemplary Zn film 110 with one or more layers of coating 120 having one or more layers of coating 225 from different coating methods and processes.

FIG. 3 is a schematic illustration of an exemplary Zn film 110 with one or more layers of coating 120 on a current collector substrate 335 with a substrate coating layer 330.

FIG. 4 is a schematic illustration of an exemplary anode 400 including Zn layer 110 with one or more first layers of coating 120 having one or more second layers of coating 225 from different coating methods and processes on a current collector substrate 335 with a substrate coating layer 330.

FIG. 5 is a schematic illustration of an exemplary Zn particle 510 with one of more layers of coating 520.

FIG. 6 is a schematic illustration of an exemplary Zn particle 610 with one of more layers of coating 620 having one or more layers of coating 625 from different coating methods and processes.

FIG. 7 is a schematic illustration of an exemplary composite structure comprising of a coated Zn particle 500 or 600, a binder 720, one or more conductive particles 730, and one or more additives 740 on a current collector substrate 710 with a coating layer 715.

FIG. 8 is a schematic illustration of an exemplary composite structure comprising of a coated Zn particle 500 or 600, a binder 820, one or more conductive particles 830, one or more additives 840, and deposited Zn 850 on a current collector substrate 710 with a coating layer 715.

FIG. 9 is a schematic illustration of an exemplary porous medium 910 with deposited Zn 920.

FIG. 10 is a flowchart of an exemplary manufacturing process of a composite structure.

FIG. 11 is a flowchart of an exemplary manufacturing process of a Zn film.

FIG. 12 is an exemplary Zn-based battery system comprising of a Zn anode 1210, a cathode 1220, a separator 1230, and an electrolyte 1240.

FIG. 13 is a plot of voltage versus time for charging and discharging an example battery including an Ni-plated carbon fiber conductive layer is coated onto Cu substrate, and a 50 um Zn film is coated onto the composite substrate.

FIG. 14 is a plot of voltage versus time for charging and discharging an example battery including a pristine Zn foil with no pretreatment and coating in a Zn|Zn symmetric cell.

FIG. 15 is a plot of voltage versus time for charging and discharging an example battery including an ALD (atomic layer deposition)-coated 25 um thick Zn foil in a Zn|Zn symmetric cell. The cell shows lowered polarization voltage of 0.06V greater than non-coated Zn foil.

FIG. 16 is a plot of voltage versus time for charging and discharging an example battery with a pristine 25 um thick Zm foil and the ALD-coated 25 um thick Zn foil.

FIG. 17 is a voltage versus time plot of charging and discharging an example battery including a pristine ZnC composite anode with no additional coating treatment in a Zn|Zn symmetric cell.

FIG. 18 is a voltage versus time plot of charging and discharging an example battery including the uncoated ZnC composite anode. The plot shows a lifetime of about 110 cycles. The loading capacity of ZnC anode is 4 mAh/cm2 and the cycling test is performed at current density of 2 mA/cm2 until reaching 2 mAh/cm2.

FIG. 19 is a voltage versus time plot of charging and discharging an example battery including ZnC composite anode with additional coating treatment through atomic layer deposition method in a Zn|Zn symmetric cell. The cell shows much improved cycling life of over 250 cycles.

FIGS. 20 and 21 are voltage versus time plots of charging and discharging two example batteries, the first battery including the uncoated ZnC composite (FIG. 20) and the second battery including the coated ZnC composite (FIG. 21).

FIG. 22 is a plot of discharge capacity (mAh/cm2) versus cycles of an example battery including matching ALD coated 25 um Zn anode with MnO2 cathode.

FIG. 23 is a voltage versus time plot of charging and discharging an example battery including matching ALD coated 25 um Zn anode with MnO2 cathode.

FIG. 24 is a voltage versus time plot of charging and discharging an example battery including matching Zn anode with MnO2 cathode, in which Zn is electrodeposited onto chemically etched Cu foil substrate in 0.1M H2SO4 acid.

FIG. 25 is a plot of capacity versus cycles for the battery of FIG. 24.

FIG. 26 is a plot of voltage versus capacity for a full cell performance demonstration by matching Zn anode with MnO2 cathode, in which Zn is electrodeposited onto chemically etched Cu foil substrate in a 0.1M H2SO4 acid.

FIG. 27 is a plot of charge capacity and discharge capacity for the cell of FIG. 26.

FIG. 28A is a picture of a Zn-based anode with an untreated stainless steel substrate.

FIG. 28B is a picture of a Zn-based anode with an untreated titanium substrate.

FIG. 28C is a picture of a Zn-based anode with an untreated copper substrate.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

This disclosure provides one or more protective coating layers for inhibiting dissolution of Zn into an acidic electrolyte. These protective coatings contribute to the suppression of passivation, oxidation, reduction, and degradation of Zn. Because the substrate which Zn loads on also suffers from corrosion effects such as galvanic corrosion and acidic corrosion, this disclosure provides a method of engineering the substrate to protect from corrosion. For suppressing Zn dendrite growth and the subsequent generation of dead Zn particles, this disclosure provides a method of generating a conductive and porous matrix to stably accommodate Zn during the deposition and dissolution electrochemical reactions by generating a composite structure or etching out a substrate. Example electrodes include a generated composite or a porous structure, which is followed by co-depositing Zn and other additive elements to fill the pores and increase the loading amount, contributing to larger capacity and energy. With this addition, example battery systems include an alloying strategy to minimize corrosion, dissolution, passivation, and degradation. In addition to the electrode engineering, example battery systems introduce functionalized electrode and electrolyte additives to suppress degradation and improve overall performance. From these collective solutions, battery systems of this disclosure provide a scalable and commercialize-able method by producing a Zn anode that shows suppressed formation of dendrites and dead Zn resulting in an extended cycle life and low overpotential. This reliable strategy to construct a novel Zn-carbon composite anode for dendrite-free Zn metal anodes will open a new avenue to the practical employment of Zn batteries.

One example embodiment includes a composite comprising of Zn powder, carbonaceous powders, and polymeric binder. Hereafter, this may be referred to as a Zn—C composite.

Another example embodiment includes one or more coatings on Zn powder, Zn foil, Zn disc, Zn ribbon, deposited Zn, and other forms of Zn metal, and a substrate.

Another example embodiment includes a surface alloying on Zn and substrate surfaces by one or more elements.

Another example embodiment includes one or more additives in the electrode.

Another example embodiment includes one or more additives in the electrolyte.

Another example embodiment is a combination of two or more processes of any of the above.

### DETAILED DESCRIPTION

Example methods of producing composite battery anode for zinc-based battery device. Example composite includes a pretreated Zn film with one to multiple coating layers on a pretreated current collector substrate with one to multiple coating layers. Example composite includes a pretreated anode composite of Zn powder, carbon powder and polymer binder with additional one to multiple coating layers, and on a pretreated current collector substrate with one to multiple coating layers. Example methods of producing Zn—C composite electrode and Zn film include surface pretreatment of Zn powder and Zn film, a coating on the Zn powder and Zn film, utilization of additives, and generation of a composite by using carbonaceous materials and a polymeric binder.

The surface pretreatment of Zn powder and Zn film may include one or more of cleaning the surface, removing impurities, and peeling off an oxide layer to prepare for the subsequent coating process. The coating of the surface pretreated Zn powder and Zn film is designed to protect the surface from degradation during battery operation. The carbonaceous materials are used for generating a porous medium with decent electrical conductivity, and the polymeric binder forms a composite by binding all the components. The additives deliver improved electrical conductivity and mechanical strength.

Example processes may include preparing etched zinc powder and zinc film. The pretreatment of the etched zinc powder and zinc film may include one or more of stirring, sonicating, and agitating Zn in an acidic solution; the acidic solution includes HCl, H₂SO₄, or HNO₃ aqueous solutions with various concentrations; cleaning in DI water and/or ethanol and/or IPA; performing filtration to sort out impurities generated during the etching process; and performing a drying process in vacuum or ambient atmosphere.

Example processes may include generating a coating on the zinc powder and Zn film. The coating process may include one or more of: performing a chemical coating method such as but not limited to solid state mixing, wet mixing, sol-gel method, and hydrothermal method; performing a deposition technique such as but not limited to atomic layer deposition, chemical vapor deposition, physical vapor deposition, pulsed laser deposition, thermal evaporation, and sputtering; and the coating materials include but are not limited to polymer, carbon, oxides, nitrides, chlorides, carbides, cyanides, and phosphates.

Example processes may include forming an alloy with other metals such as but not limited to zinc, copper, silver, aluminum, gold, platinum, zirconium, titanium, tin, silicon, germanium, tin, and indium. The method of forming an alloy includes but is not limited to wet mixing, dry mixing, chemical treatment, and heat treatment. The form of the alloy includes but is not limited to particle, powder, foil, plate, and film to be utilized for active material and/or substrate.

Example processes may include incorporation of additives. An additive is a nano-sized particle with an exceptional electrical conductivity. Example additives may include but are not limited to graphene, carbon nanotubes, carbon black, activated carbon, carbon fibers, metal powder, and conductive or non-conductive polymers.

Example processes may include producing a composite with carbonaceous materials and a polymeric binder. Example carbonaceous materials may include but are not limited to amorphous carbon, hard carbon, soft carbon, graphite, activated graphite, conductive graphite, synthetic graphite, natural graphite, graphene, and carbon nanotubes. Example polymeric binders may include but are not limited to polypyrrole, polyaniline, poly(3,4-ethylenedioxythiophene), polyvinylidene fluoride, polytetrafluoroethylene, ethyl cellulose, nitrocellulose or carboxymethyl cellulose, styrene-butadiene rubber, and acrylate-type binders. Example solvents may include but are not limited to N-Methyl-2-pyrrolidone (NMP), dimethylformamide (DMF), dimethylacetamide (DMAC), triethyl phosphate (TEP) and dimethyl sulfoxide (DMSO), dimethyl carbonate, ethyl-methyl carbonate, diethyl carbonate, water, ethanol, isopropyl alcohol, and acetone. Examples of methods of mixing these components may include but are not limited to ball milling, centrifugal mixing, vibratory mixing, shear mixing, and sonication. In example embodiments, the mixed slurry is coated onto the current collector substrate to form the final product after the subsequent drying step. Example current collector substrates include but are not limited to one or more of metal mesh, metal plate, and metal foil including but not limited to copper, stainless steel, brass, stainless steel, nickel, zinc, aluminum, titanium and their composites. Example current collector substrates may include but are not limited to one or more of carbon paper, carbon felt, graphite felt, carbon cloth, and conductive polymer membrane. In example embodiments, Zn is deposited into the porous composite along with other metal elements such as but not limited to Cu, In, Sn, Al, Ga, Ge, Ni, Mn, Co, Nb, Cr, V, Ti, Zr, Ag, Au, Pd, Pt, Si, Fe, stainless steel, and their alloys.

Example processes may include post treatment on the composite Zn anode. Example processes include thermal annealing with temperature ranging from 80° C. to 1500° C. under ambient, oxidized, or reduced environment such as argon, nitrogen, hydrogen and their mixture. The annealing time ranges from 0.1 hour to 48 hours.

Another embodiment of the invention is the method of treatment of current collector substrates. The current collector is selected from the group consisting of carbon paper, carbon felt, graphite felt, graphite foil, carbon cloth, conductive polymer membranes, metal mesh, metal plate, and metal foil; and the metal is selected from the group consisting of copper, stainless steel, brass, stainless steel, nickel, zinc, aluminum, titanium and their composites. The method includes acid etching of the metal substrate to generate a porous surface structure. The method also includes acid, plasma, and/or thermal treatment of carbon paper, carbon felt, carbon cloth, and polymer membrane to modify the fiber conductivity, surface functional groups, ion selectivity, and the wetting property. The method also includes coating the substrate with graphene, active carbon, carbon nanotube, carbon fiber, electrical conductive polymer, polymer binder, electrical conductive oxides, carbides, metal powders, metal fibers, and/or their combinations.

Example processes may include casting carbon, polymer, oxides, metals and their combinations on the treated current collector substrate. Example methods of casting carbon, polymer, oxides, metals and their combinations on the treated current collector substrate may include one or more of the following: brush painting, spin coating, blade coating, dip-coating, electroplating, pulse electroplating, electrodeposition, constant voltage electrodeposition, constant current electrodeposition, pulse electrodeposition, cyclic voltammetric deposition, and electrophoretic deposition.

Example processes may include providing additives in electrolytes. The electrolyte additives contribute to suppressing the effects of corrosion of substrate, dissolution of Zn from the anode, and formation of Zn dendrite and dead Zn particles. Example additives include but are not limited to one or more of cetyltrimethylammonium bromide (CTAB), sodium dodecyl sulfate (SDS), polyethylene glycol 8000 (PEG), sodium sulfate, sodium hydroxide, sodium acetate, polypyrrole, polyaniline, polycarbonate, Poly(methyl methacrylate) (PMMA) and thiourea. With these applied electrolyte additives, the in-situ coating layer can be formed after assembling into a full battery cell by controlling voltage and current to apply electrodeposition.

Example battery systems provide a scalable and commercialize-able method of producing a Zn anode that shows suppressed formation of dendrites and dead Zn resulting in an extended cycle life and low overpotential via generating a carbon composite and coating layers. With this, example processes include an alloying strategy to minimize corrosion, dissolution, passivation, and degradation on both active materials and substrates. In addition to the electrode engineering, example battery systems and processes introduce functionalized electrode and electrolyte additives to suppress degradation and improve overall performance. This reliable strategy to construct a novel dendrite-free degradation-free Zn-based anode may provide a way for practical employment of Zn batteries.

FIG. 1 is a schematic illustration of an example anode 100 including a Zn layer 110 with one or more first coating layers 120. In certain embodiments the Zn layer 110 includes one or more of Zn film or Zn powder. In certain example embodiments, the Zn layer 110 is disposed on anode 100. Example first coating layers 120 include one or more of Al2O3, SiO2, V2O5, CaCO3, TiO2, HfO2, In2O3, ZnO, ZrO2.

In example embodiments, the Zn layer 110 is pretreated by one or more of polishing, grinding, sanding, etching, and cleaning and the pretreated current collector substrate is pretreated by one or more of polishing, grinding, sanding, etching, and cleaning. The pretreatment by etching may include one or more of stirring, sonicating, and agitating in an acidic solution. The acidic solution may include one or more of HCl, H2SO4, H3PO4, H3BO3, CH3COOH or HNO3 aqueous solutions with a concentration between 0.01 mol/L, 0.02 mol/L, 0.03 mol/L, 0.04 mol/L, 0.05 mol/L, 0.06 mol/L, 0.07 mol/L, 0.08 mol/L, 0.09 mol/L, 0.1 mol/L, 0.2 mol/L, 0.3 mol/L, 0.4 mol/L, 0.5 mol/L, 0.6 mol/L, 0.7 mol/L, 0.8 mol/L, 0.9 mol/L, 1 mol/L, 2 mol/L, 3 mol/L. In example embodiments, the pretreatment includes cleaning with a cleaning solution that includes one or more of water, ethanol, isopropyl alcohol, acetone, and methanol. In example embodiments, the Zn layer 110 is prepared using one or more of a drying under vacuum, drying with convection, and drying in an ambient atmosphere.

Example first coating layers 120 includes one or more of a carbon coating, composite coating, polymer coating, metal oxide coating, metal carbide coating, metal carbonate coating, metal nitride, metal coating, and/or surface alloying. In example embodiments, the first coating layer 120 is applied by one or more of brush painting, spin coating, blade coating, dip-coating, electroplating, pulse electroplating, electrodeposition, constant voltage electrodeposition, constant current electrodeposition, pulse electrodeposition, cyclic voltammetric deposition, and electrophoretic deposition. In example embodiments, the first coating layer 120 is formed in-situ after assembling into a full battery cell by controlling voltage and current for electrodeposition, and electrolyte is included with additives comprising of one or more of cetyltrimethylammonium bromide (CTAB), sodium dodecyl sulfate (SDS), polyethylene glycol 8000 (PEG), sodium sulfate, sodium hydroxide, sodium acetate, polypyrrole, polyaniline, polycarbonate, Poly(methyl methacrylate) (PMMA) and thiourea.

Example Zn layers 110 includes at least one additional deposition of Zn. In example embodiments, the additional deposition of Zn further includes one or more of Cu, Li, In, Sn, Al, Ga, Ge, Ni, Mn, Co, Nb, Cr, V, Ti, Zr, Ag, Au, Pd, Pt, Si, Fe, carbon, and their alloys. In example embodiments, the additional Zn deposition is performed by one or more of atomic layer deposition, chemical vapor deposition, physical vapor deposition, pulsed laser deposition, thermal evaporation, electrodeposition, or and sputtering. Example embodiments of the Zn layer further include post thermal annealing that may be applied with temperature ranging from 80° C. to 1500° C. under ambient, oxidized, or reduced environment such as argon, nitrogen, hydrogen and their mixture for between 0.1 hour to 48 hours. In example embodiments the annealing is applied for 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, 14.1, 14.2, 14.3, 14.4, 14.5, 14.6, 14.7, 14.8, 14.9, 15, 15.1, 15.2, 15.3, 15.4, 15.5, 15.6, 15.7, 15.8, 15.9, 16, 16.1, 16.2, 16.3, 16.4, 16.5, 16.6, 16.7, 16.8, 16.9, 17, 17.1, 17.2, 17.3, 17.4, 17.5, 17.6, 17.7, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 20.1, 20.2, 20.3, 20.4, 20.5, 20.6, 20.7, 20.8, 20.9, 21, 21.1, 21.2, 21.3, 21.4, 21.5, 21.6, 21.7, 21.8, 21.9, 22, 22.1, 22.2, 22.3, 22.4, 22.5, 22.6, 22.7, 22.8, 22.9, 23, 23.1, 23.2, 23.3, 23.4, 23.5, 23.6, 23.7, 23.8, 23.9, 24, 24.1, 24.2, 24.3, 24.4, 24.5, 24.6, 24.7, 24.8, 24.9, 25, 25.1, 25.2, 25.3, 25.4, 25.5, 25.6, 25.7, 25.8, 25.9, 26, 26.1, 26.2, 26.3, 26.4, 26.5, 26.6, 26.7, 26.8, 26.9, 27, 27.1, 27.2, 27.3, 27.4, 27.5, 27.6, 27.7, 27.8, 27.9, 28, 28.1, 28.2, 28.3, 28.4, 28.5, 28.6, 28.7, 28.8, 28.9, 29, 29.1, 29.2, 29.3, 29.4, 29.5, 29.6, 29.7, 29.8, 29.9, 30, 30.1, 30.2, 30.3, 30.4, 30.5, 30.6, 30.7, 30.8, 30.9, 31, 31.1, 31.2, 31.3, 31.4, 31.5, 31.6, 31.7, 31.8, 31.9, 32, 32.1, 32.2, 32.3, 32.4, 32.5, 32.6, 32.7, 32.8, 32.9, 33, 33.1, 33.2, 33.3, 33.4, 33.5, 33.6, 33.7, 33.8, 33.9, 34, 34.1, 34.2, 34.3, 34.4, 34.5, 34.6, 34.7, 34.8, 34.9, 35, 35.1, 35.2, 35.3, 35.4, 35.5, 35.6, 35.7, 35.8, 35.9, 36, 36.1, 36.2, 36.3, 36.4, 36.5, 36.6, 36.7, 36.8, 36.9, 37, 37.1, 37.2, 37.3, 37.4, 37.5, 37.6, 37.7, 37.8, 37.9, 38, 38.1, 38.2, 38.3, 38.4, 38.5, 38.6, 38.7, 38.8, 38.9, 39, 39.1, 39.2, 39.3, 39.4, 39.5, 39.6, 39.7, 39.8, 39.9, 40, 40.1, 40.2, 40.3, 40.4, 40.5, 40.6, 40.7, 40.8, 40.9, 41, 41.1, 41.2, 41.3, 41.4, 41.5, 41.6, 41.7, 41.8, 41.9, 42, 42.1, 42.2, 42.3, 42.4, 42.5, 42.6, 42.7, 42.8, 42.9, 43, 43.1, 43.2, 43.3, 43.4, 43.5, 43.6, 43.7, 43.8, 43.9, 44, 44.1, 44.2, 44.3, 44.4, 44.5, 44.6, 44.7, 44.8, 44.9, 45, 45.1, 45.2, 45.3, 45.4, 45.5, 45.6, 45.7, 45.8, 45.9, 46, 46.1, 46.2, 46.3, 46.4, 46.5, 46.6, 46.7, 46.8, 46.9, 47, 47.1, 47.2, 47.3, 47.4, 47.5, 47.6, 47.7, 47.8, 47.9, 48 hours.

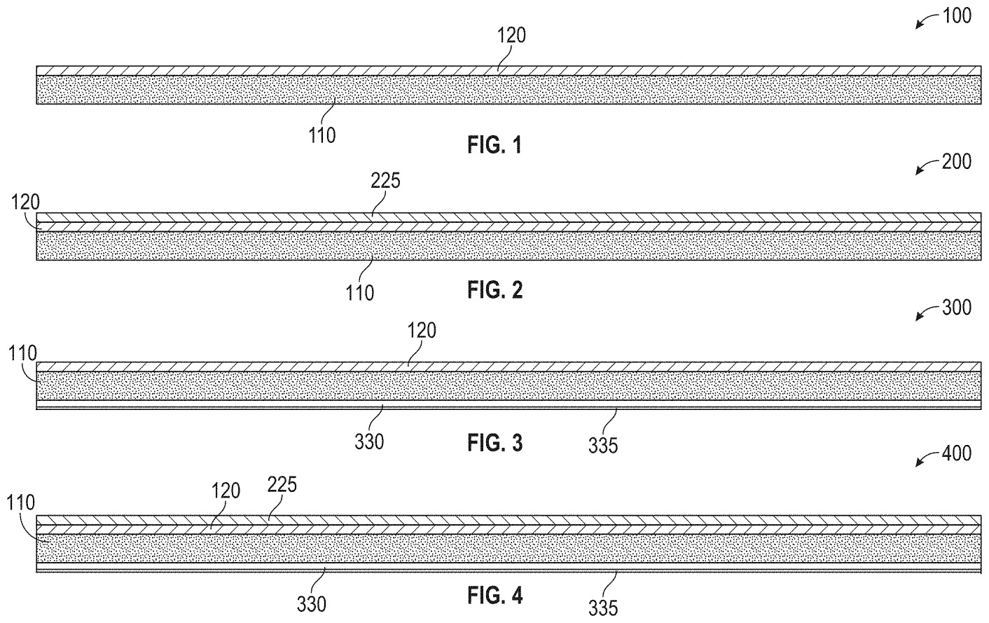

Example first coating layer 120 and second coating layer 225 (discussed above with respect to FIG. 2) may be formed with an alloy with one or more other metals including one or more metals selected from the group consisting of Cu, Li, In, Sn, Al, Ga, Ge, Ni, Mn, Co, Nb, Cr, V, Ti, Zr, Ag, Au, Pd, Pt, Si, Fe, carbon and their alloys. In example embodiments, the alloy with one or more other metals is formed forming the alloy includes by one or more of wet mixing, dry mixing, chemical treatment, and heat treatment.

Example Zn-based batteries may further include a current collector selected from the group consisting of carbon paper, carbon felt, graphite felt, graphite foil, carbon cloth, conductive polymer membranes, metal mesh, metal plate, and metal foil; and the metal is selected from the group consisting of copper, stainless steel, brass, stainless steel, nickel, zinc, aluminum, titanium and their composites. In example embodiments, the current collector is pretreated by one or more of washing, polishing, etching, doping, coating, and alloying. For example, the current collector may be coated in one or more coating layer materials selected from the group consisting of graphene, amorphous carbon, activated carbon, carbon fiber, carbon nanotubes, metal oxides, electrical conductive oxides, carbides, metal powders, metal fibers, and conductive or non-conductive polymers.

FIG. 2 is a schematic illustration of an exemplary anode 200 including Zn layer 110 with one or more layers of coating 120 and further including one or more second layers of coating 225. Example second coating layers 225 includes one or more of a carbon coating, composite coating, polymer coating, metal oxide coating, metal carbide coating, metal carbonate coating, metal nitride, metal coating, and/or surface alloying. In example embodiments, the second coating layer 225 is applied by one or more of brush painting, spin coating, blade coating, dip-coating, electroplating, pulse electroplating, electrodeposition, constant voltage electrodeposition, constant current electrodeposition, pulse electrodeposition, cyclic voltammetric deposition, and electrophoretic deposition. In example embodiments, the second coating layer 225 is formed in-situ after assembling into a full battery cell by controlling voltage and current for electrodeposition, and electrolyte is included with additives comprising of one or more of cetyltrimethylammonium bromide (CTAB), sodium dodecyl sulfate (SDS), polyethylene glycol 8000 (PEG), sodium sulfate, sodium hydroxide, sodium acetate, polypyrrole, polyaniline, polycarbonate, Poly(methyl methacrylate) (PMMA) and thiourea.

FIG. 3 is a schematic illustration of an exemplary anode 300 including Zn layer 110, one or more first coating layers 120, and a current collector substrate 335. In example embodiments, the substrate 330 is coated in one or more layers of substrate coating 330. One example coating copper foil substrate with carbon composition with blade coating method. Example substrate coating layers 330 includes one or more of a carbon coating, composite coating, polymer coating, metal oxide coating, metal carbide coating, metal carbonate coating, metal nitride, metal coating, and/or surface alloying. In example embodiments, the substrate coating layer is applied by one or more of brush painting, spin coating, blade coating, dip-coating, electroplating, pulse electroplating, electrodeposition, constant voltage electrodeposition, constant current electrodeposition, pulse electrodeposition, cyclic voltammetric deposition, and electrophoretic deposition. In example embodiments, the substrate coating layer is formed in-situ after assembling into a full battery cell by controlling voltage and current for electrodeposition, and electrolyte is included with additives comprising of one or more of cetyltrimethylammonium bromide (CTAB), sodium dodecyl sulfate (SDS), polyethylene glycol 8000 (PEG), sodium sulfate, sodium hydroxide, sodium acetate, polypyrrole, polyaniline, polycarbonate, Poly(methyl methacrylate) (PMMA) and thiourea.

FIG. 4 is a schematic illustration of an exemplary anode 400 including Zn layer 110 with one or more first layers of coating 120 having one or more second layers of coating 225 from different coating methods and processes on a current collector substrate 335 with a substrate coating layer 330.

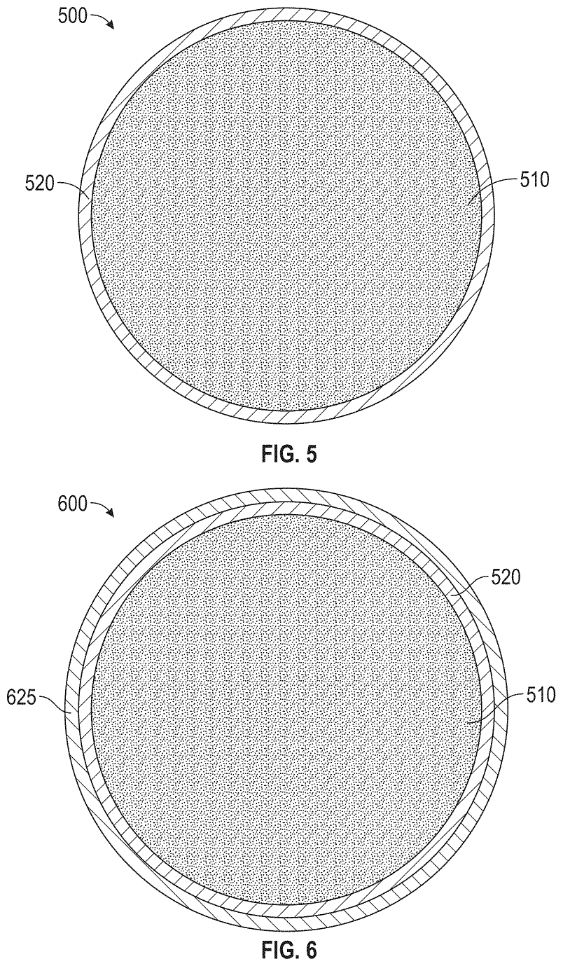

FIG. 5 is a schematic illustration of an exemplary Zn particle 510 with one of more first layers of coating 520. The one or more first layers of coating 520 may include any of the first coating layers 120 discussed above with respect of FIG. 1. The layers of coating 520 may be applied according to any of the processes discussed above with respect to FIG. 1

FIG. 6 is a schematic illustration of an exemplary Zn particle 510 with one of more layers of coating 520 having one or more second layers of coating 625 from different coating methods and processes. The layers of coating 625 may be applied according to any of the processes discussed above with respect to FIG. 1. In some example embodiments, the coating layer 520 is designed to suppress both dendrite growth and corrosion. In some example, one coating layer is designed to suppress dendrite growth and another layer to suppress corrosion.

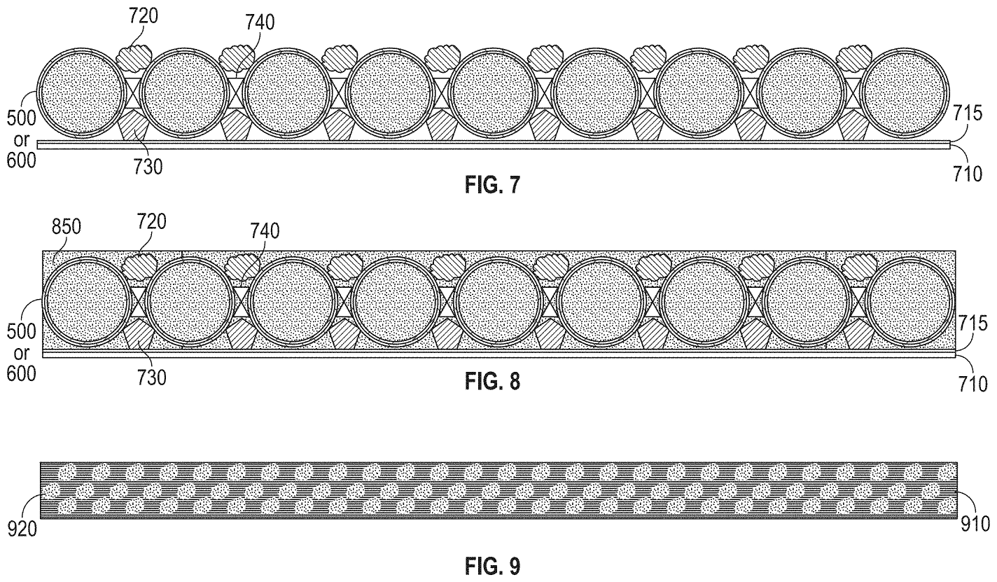

FIG. 7 is a schematic illustration of an exemplary composite structure including a coated Zn particle 500 or 600, a binder 720, one or more conductive particles 730, and one or more additives 740 on a current collector substrate 710 with a coating layer 715. The coated layer on Zn particle helps suppress dendrite growth and protect from corrosion due to contact with electrolyte. The conductive particles provide extra surface areas that enable more Zn growth seeding sites to further suppress dendrite growth. The extra coating layer on the substrate increases electron transfer between Zn and substrate thus increase Zn seeding homogeneity to suppress dendrite growth.

FIG. 8 is a schematic illustration of an exemplary composite structure including a coated Zn particle 500 or 600, a binder 720, one or more conductive particles 730, one or more additives 740, and deposited Zn 850 on a current collector substrate 710 with a coating layer 715. Further deposited Zn increases the capacity of the anode and suppress the corrosion due to decreased pore area. thus increase Zn seeding homogeneity to suppress dendrite growth.

FIG. 9 is a schematic illustration of an exemplary porous medium 910 with deposited Zn 920. The porous medium provides high surface areas that effectively increase the Zn seeding site that suppress dendrite growth. The pores also suppress dendrite growth towards the cathode thus decrease the possibility of short-circuit.

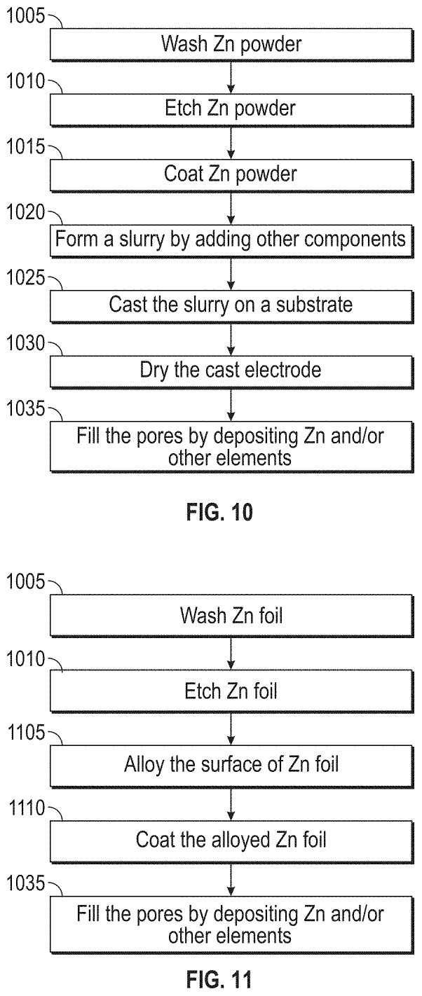

FIG. 10 is a flowchart of an exemplary manufacturing process of a composite anode structure. For the composite anode manufactured by the process of FIG. 10, the Zn layer 110 may include Zn powder. In example embodiments, the Zn layer 110 includes a composite of Zn powder, carbon powder, and a polymer binder, with a composition ratio for Zn powder between 30% to 80%, carbon powder between 30% to 80%, and polymer binder between 10% to 20%. In example embodiments, the polymeric binder is selected from the group consisting of polypyrrole, polyaniline, poly(3,4-ethylenedioxythiophene), polyvinylidene fluoride, polytetrafluoroethylene, ethyl cellulose, styrene-butadiene rubber, nitrocellulose or carboxymethyl cellulose, and acrylate-type binders. In certain example embodiments, the Zn powder size is between 10 nanometers and 100 micrometers.

The process includes one or more pretreatments of the Zn layer 110 and/or the substrate 430. Pretreatment of the Zn layer 110 may include one or more of polishing, grinding, sanding, etching, and cleaning and the pretreated current collector substrate is pretreated by one or more of polishing, grinding, sanding, etching, and cleaning. Pretreatment of the substrate 330 also may include one or more of polishing, grinding, sanding, etching, and cleaning and the pretreated current collector substrate is pretreated by one or more of polishing, grinding, sanding, etching, and cleaning.

For example, the Zn layer 110 is cleaned (block 1005). Cleaning may includes disposing the Zn layer 110 or the substrate 330 in a cleaning solution. The cleaning solution may include one or more of water, ethanol, isopropyl alcohol, acetone, and methanol.

The Zn layer 110 is etched (block 1010). Etching may include one or more of stirring, sonicating, and agitating in an acidic solution. In certain embodiments, etching is performed with an acidic solution, wherein the acidic solution includes one or more of HCl, H2SO4, HNO3, H3BO3, CH3COOH at the concentration of between 0.001 mol/L to 10 mol/L.

The Zn layer 110 is coated (block 1015). The coating may be performed for Zn power based-Zn layer 110. The Zn layer 110 may be coated by one or more materials selected from the group consisting of a metal oxide, a metal, a carbonaceous material, and a polymer. In example embodiments the carbonaceous material includes one or more of carbon black, acetylene black, conductive carbon, amorphous carbon, soft carbon, hard carbon, conductive graphite, activated graphite, natural graphite, artificial graphite, synthetic carbon, graphene, carbon fibers and carbon nanotubes. In example embodiments, the Zn layer 110 is coated by one or more metal oxides selected from titanium oxides, zirconium oxides, aluminum oxides, hafnium oxides, copper oxides, indium oxides, silicon oxides, tin oxides, silver oxides, vanadium oxides, chromium oxides, iron oxides, cobalt oxides, nickel oxides, manganese oxides, niobium oxides, molybdenum oxides, and germanium oxides. In example embodiments, the Zn layer 110 is coated by one or more metal elements selected from Cu, In, Sn, Al, Ga, Ge, Ni, Mn, Co, Nb, Cr, V, Ti, Zr, Ag, Au, Pd, Pt, Si, and Fe by forming an alloy on the surface. In example embodiments, the Zn layer 110 is coated by one or more carbon materials selected from amorphous carbon, graphite, natural graphite, synthetic graphite, activated graphite, conductive graphite, graphene, carbon nanotubes, hard carbon, and soft carbon. In example embodiments, the Zn layer 110 is coated by one or more conductive polymers selected from polyaniline, polypyrrole, and polyvinylpyrrolidone. In example embodiments, the Zn layer 110 is coated by one or more ion-selective materials selected from polyvinyl chloride, polyvinyl chloride-valinomycin, polyvinyl chloride-tridodecylamine, dibenzylamine, and octyldibenzylamine. In example embodiments, the Zn layer 110 is coated by one or more of chemical coating method and/or a deposition method. The chemical coating may include one or more of solid-state mixing, wet mixing, sol-gel method, precipitation, co-precipitation and hydrothermal methods. The deposition coating may include one or more of atomic layer deposition, chemical vapor deposition, physical vapor deposition, pulsed laser deposition, thermal evaporation, electrodeposition, or sputtering.

The process further includes forming a slurry by adding other components to the coated Zn powder. Example of the components includes carbon powder, polymer binder and metal powders. The powders are well mixed and dissolved in solvents. Example solvents include or more of -Methyl-2-pyrrolidone (NMP), dimethylformamide (DMF), dimethylacetamide (DMAC), triethyl phosphate (TEP) and dimethyl sulfoxide (DMSO), dimethyl carbonate, ethyl-methyl carbonate, diethyl carbonate, water, ethanol, isopropyl alcohol, and acetone. (block 1020). By mixing the solvent and powder components, the targeted slurry is formed.

The process further includes casting the slurry on a substrate (block 1025). Example casting method includes one or more of blade coating, slot-die coating, spray coating, roll-to-roll coating, brush painting, spin coating, dip-coating.

The Zn anode is dried (block 1030). Example drying may include one or more of drying under vacuum, drying with convection, and drying in an ambient atmosphere.

The pores of the Zn anode are filled by depositing Zn and/or other elements (block 1035). Example of depositing Zn and/or other elements in to the pores of Zn anode include chemical deposition, electrodeposition, electrochemical deposition, chemical vapor deposition, atomic layer deposition, plasma deposition, pulsed laser deposition, physical vapor deposition, blade coating, slot-die coating, spray coating, roll-to-roll coating, brush painting, spin coating, dip coating.

In example embodiments, the composite anode further includes a current collector. The current collector may be formed from one or more of carbon paper, carbon felt, graphite felt, graphite foil, carbon cloth, and conductive polymer membranes, metal mesh, metal plate, and metal foil; and the metal is selected from the group consisting of copper, stainless steel, brass, stainless steel, nickel, zinc, aluminum, titanium and their composites. The current collector may undergo a surface pretreatment. Example surface pretreatments may include one or more of washing, polishing, etching, doping, coating, and alloying. The current collector may be coating in a current collector coating layer. The current collector coating layer may include one or more of graphene, amorphous carbon, activated carbon, carbon fiber, carbon nanotubes, metal oxides, electrically conductive oxides, carbides, metal powders, metal fibers, and conductive or non-conductive polymers.

The composite anode may further be formed from one or more of graphene, multi-layer graphene, amorphous carbon, activated carbon, carbon fiber, carbon nanotubes, multi-walled carbon nanotubes, metal powder, and conductive or non-conductive polymers. Example metal powders include one or more of Cu, In, Sn, Al, Ga, Ge, Ni, Mn, Co, Nb, Cr, V, Ti, Zr, Ag, Au, Pd, Pt, Si, Fe, stainless steel, and their alloys. In example embodiments, the process includes an additional deposition of Zn into the formed composite anode with or without other elements. Example other elements include one or more of Cu, Li, In, Sn, Al, Ga, Ge, Ni, Mn, Co, Nb, Cr, V, Ti, Zr, Ag, Au, Pd, Pt, Si, Fe, carbon, and their alloys. The additional Zn deposition may be performed by one or more of atomic layer deposition, chemical vapor deposition, physical vapor deposition, pulsed laser deposition, thermal evaporation, electrodeposition, or sputtering.

In certain example embodiments, one or more of blocks 1005-1035 are omitted. In example embodiments, additional steps are included in the process. In certain embodiments, block 1005-1035 are performed in an order other than that shown in FIG. 10.

FIG. 11 is a flowchart of an exemplary manufacturing process of a Zn anode including a Zn layer 110, where the Zn layer 110 includes Zn foil.

The Zn layer 110 is cleaned (block 1005), as described above with respect to FIG. 10. The Zn layer 110 is etched (block 1010), as described above with respect to FIG. 10.

The surface of the Zn-foil-based Zn layer 110 is alloyed (block 1105).

The surface of the Zn-foil based Zn layer 110 is coated in one or more first coating layers 120 (block 1110). In certain embodiments, the first coating layer 120 is further coating in one or more second coating layers 225.

The pores of the Zn anode are filled by depositing Zn and/or other elements (block 1035, as described with respect to FIG. 10).

In certain example embodiments, one or more of blocks of FIG. 11 are omitted. In example embodiments, additional steps are included in the process. In certain embodiments, the blocks of FIG. 11 are performed in an order other than that shown in FIG. 11.

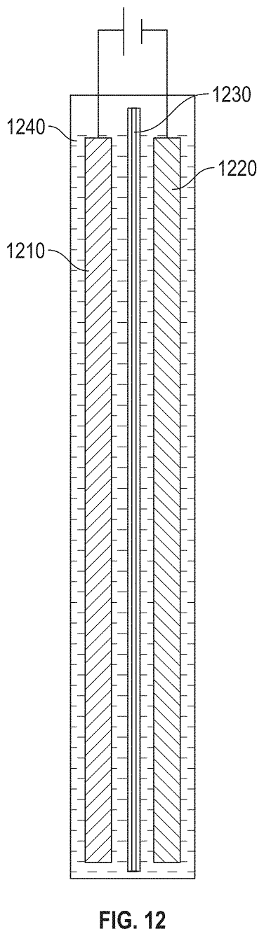

FIG. 12 is an exemplary Zn-based battery system comprising of a Zn anode 1210, a cathode 1220, a separator 1230, and an electrolyte 1240. Example Zn-based battery systems further include a venting hole at the top for gas pressure release and extra space at the bottom for dendrite collection. Example Zn-based battery systems further include connection parts for electrolyte management.

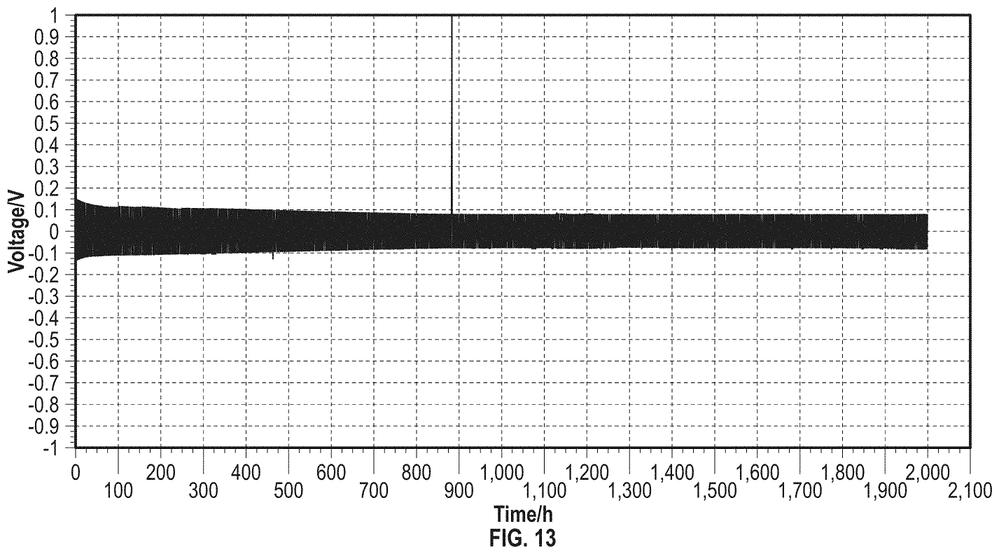

FIG. 13 is a plot of voltage versus time for charging and discharging an example battery including an Ni-plated carbon fiber conductive layer is coated onto Cu substrate, and a 50 um Zn film is coated onto the composite substrate. The Zn|Zn symmetric battery cell is cycling at 2 C rate for 2000 cycles with no additional treatment (6 mA/cm2, 12 mA/cm2).

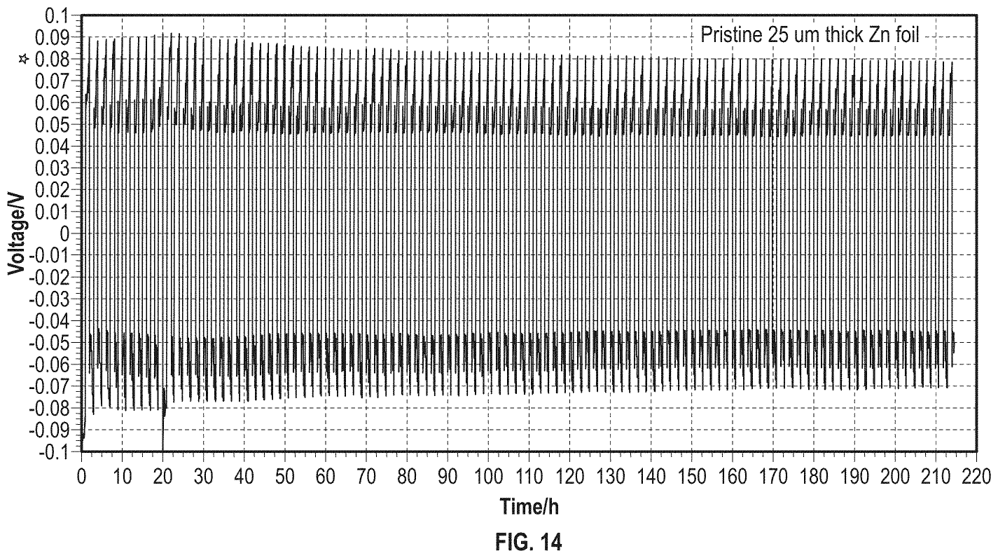

FIG. 14 is a plot of voltage versus time for charging and discharging an example battery including a pristine Zn foil with no pretreatment and coating in a Zn|Zn symmetric cell. In this cell configuration, both electrodes are composed of Zn anode and the applied electrolyte is 1M ZnSO4. The pristine foil was 25 um thick. The cell shows 0.08V polarization voltage.

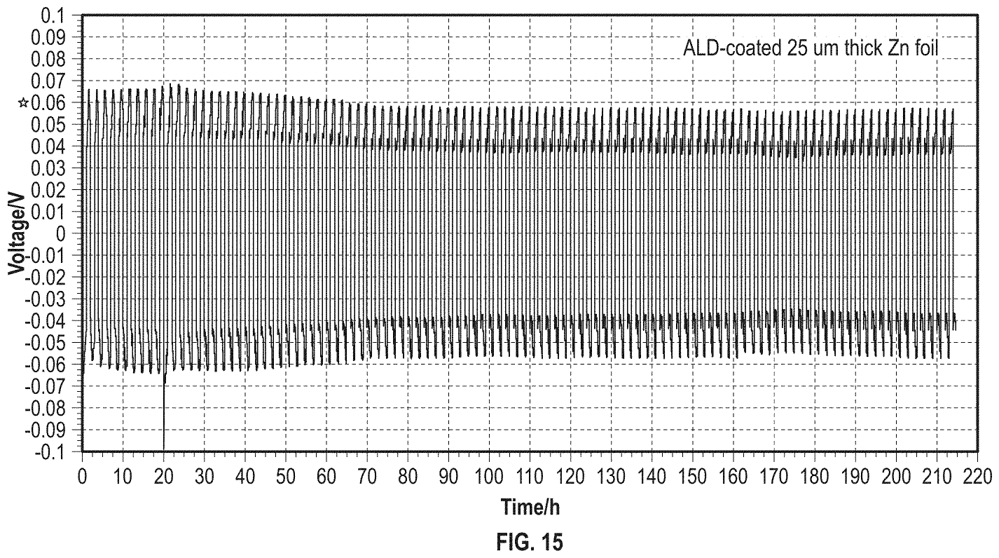

FIG. 15 is a plot of voltage versus time for charging and discharging an example battery including and 25 um thick Zn foil with atomic layer deposition coated in a Zn|Zn symmetric cell. Atomic layer deposition method grows less than 1 nm thick metal oxide, for example, TiO₂, onto the Zn foil. The testing electrolyte is also 1M ZnSO4 solution. The cell shows lowered polarization voltage of 0.06V than non-coated foil.

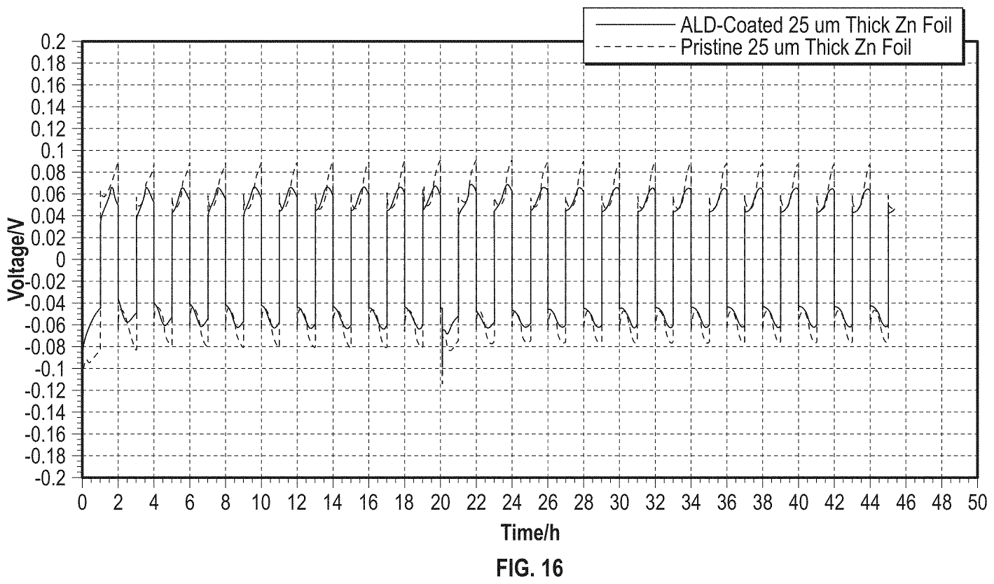

FIG. 16 is a plot of voltage versus time for charging and discharging an example battery with a pristine 25 um thick Zn foil and the ALD-coated 25 um thick Zn foil. The beneficial effect of ALD induced coating to suppress polarization is clearly revealed. With ALD coating, the polarization voltage is reduced by 25%.

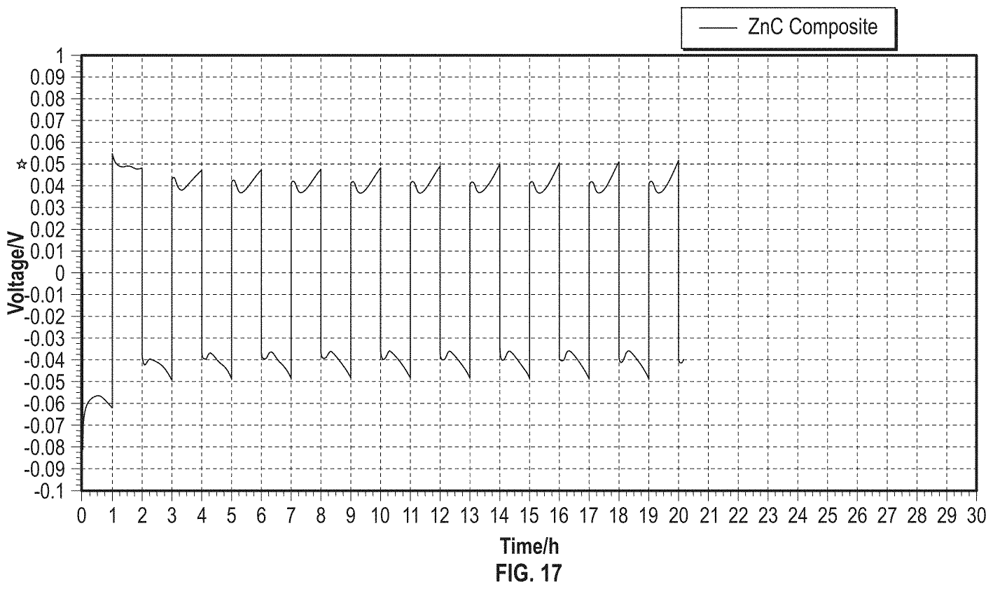

FIG. 17 is a voltage versus time plot of charging and discharging an example battery including a pristine ZnC composite anode with no additional coating treatment in a Zn|Zn symmetric cell. The example ZnC composite is composed of Zn powders, carbon powders and polymer binders. The mixed powders are dissolved in the solvent to form slurry that is casted onto metal foil to form Zn anode. The cell shows only 0.05V polarization voltage, indicating ZnC composite is better than pure Zn.

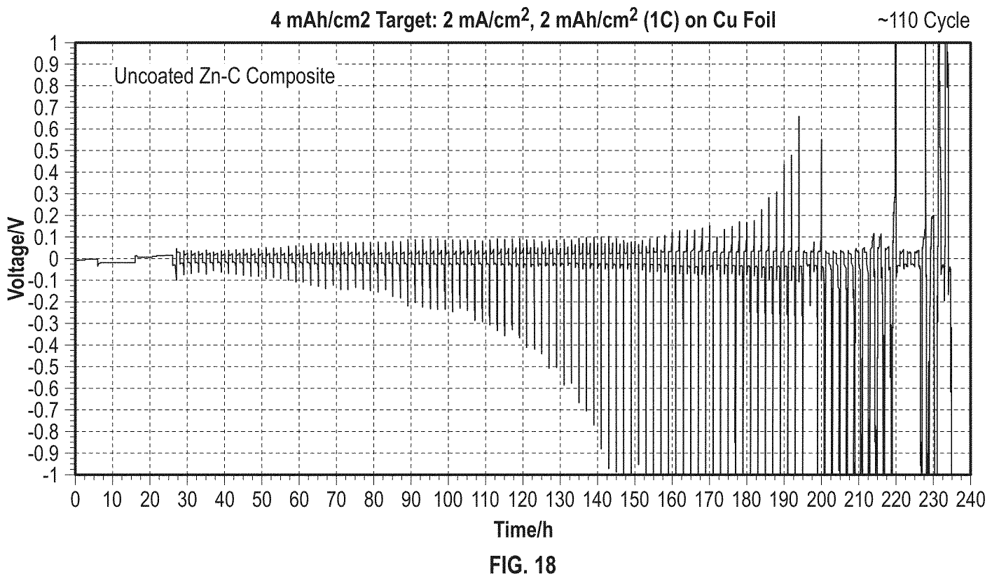

FIG. 18 is a voltage versus time plot of charging and discharging an example battery including the uncoated ZnC composite anode. The plot shows a lifetime of about 110 cycles until short circuit is happening. The loading capacity of ZnC anode is 4 mAh/cm2 and the cycling test is performed at current density of 2 mA/cm2 until reaching 2 mAh/cm2.

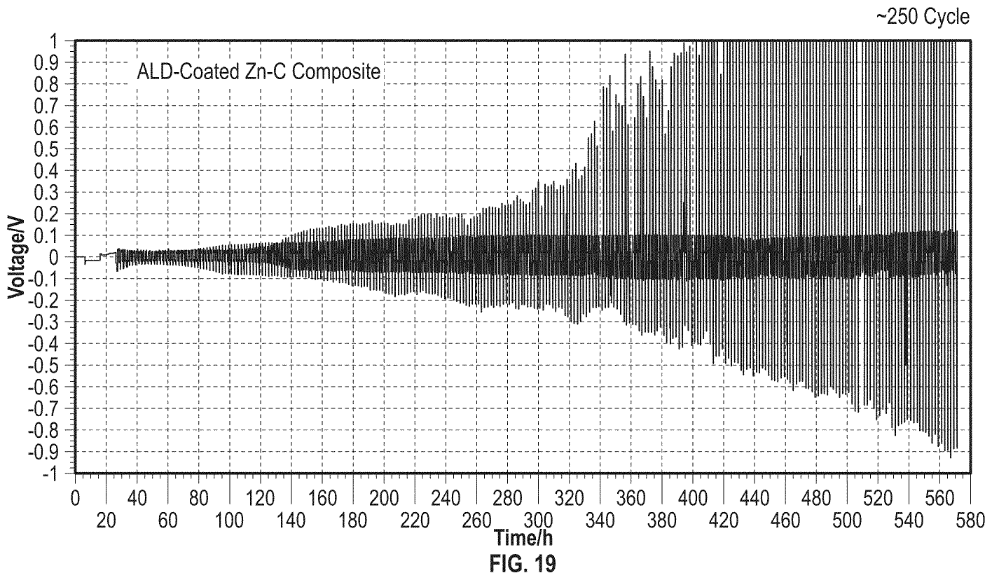

FIG. 19 is a voltage versus time plot of charging and discharging an example battery including ZnC composite anode with additional coating treatment through atomic layer deposition method in a Zn|Zn symmetric cell. The cell shows much improved cycling life of over 250 cycles. These results, together with results in FIG. 16, show that benefiting from the disclosed one or more coating layers on suppressing dendrite growth and surface corrosion, Zn film is effectively protected as shown from increased cycling life and suppressed polarization.

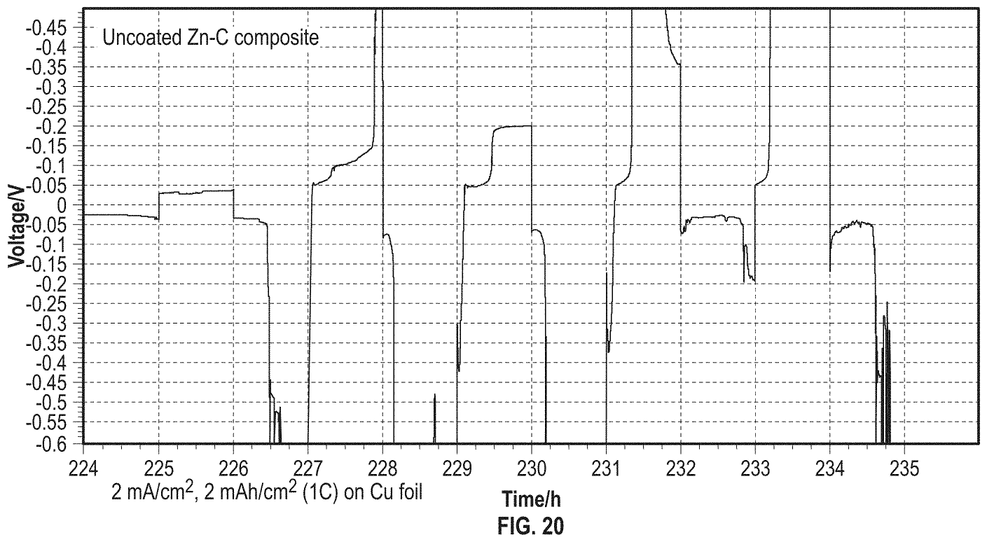

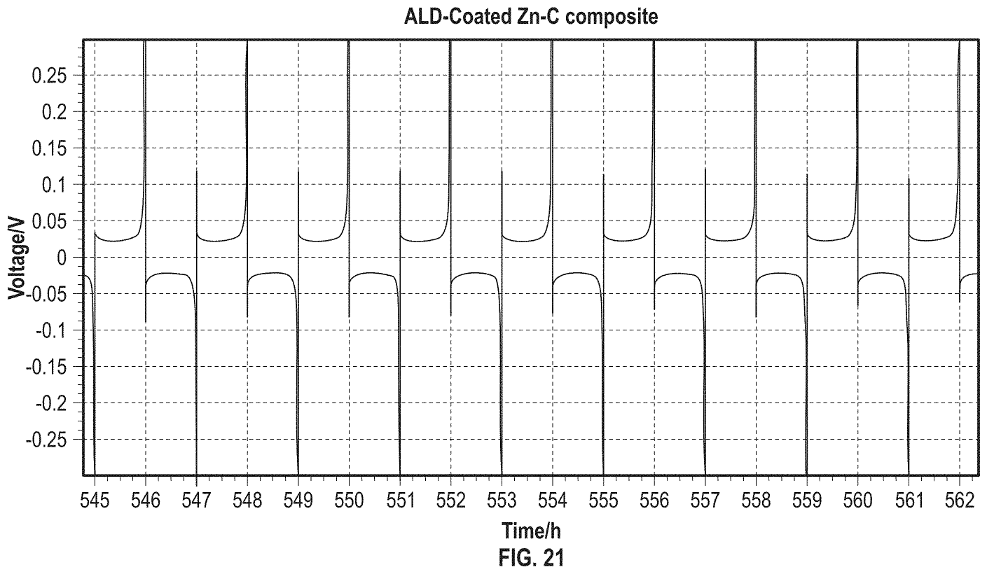

FIGS. 20 and 21 are voltage versus time plots of charging and discharging two example batteries, the first battery including the uncoated ZnC composite (FIG. 20) and the second battery including the coated ZnC composite via atomic layer deposition method (FIG. 21). The uncoated anode shows strong noises after 200 hours, indicating strong corrosion. But the ALD coated anode didn't show noise even at 560 hours, implying the beneficial effect from coating layers.

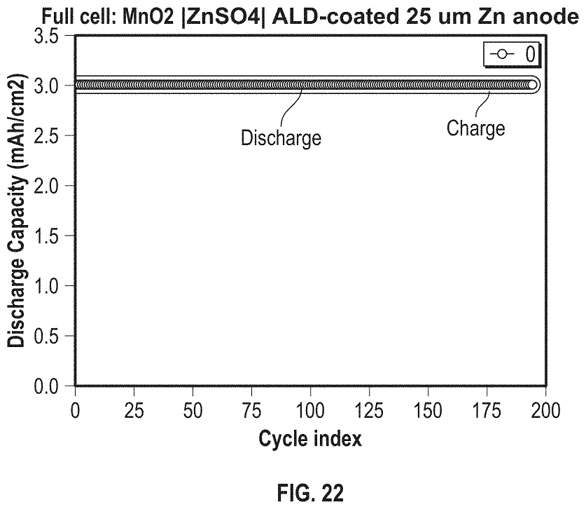

In addition to Zn|Zn symmetric cells test that proves coating effect on suppressing dendrite growth and surface corrosion. Zn—MnO2 full cell with Zn as anode, MnO2 as cathode and 1M ZnSO4 0.1M MnSO4 as electrolyte has been constructed to validate invented Zn anode on full battery performance. FIG. 22 is a plot of discharge capacity (mAh/cm2) versus cycles of an example battery including matching ALD coated 25 um Zn anode with MnO2 cathode. It shows lifetime of at least 200 cycles without degradation, and the coulombic efficiency is kept over 99%.

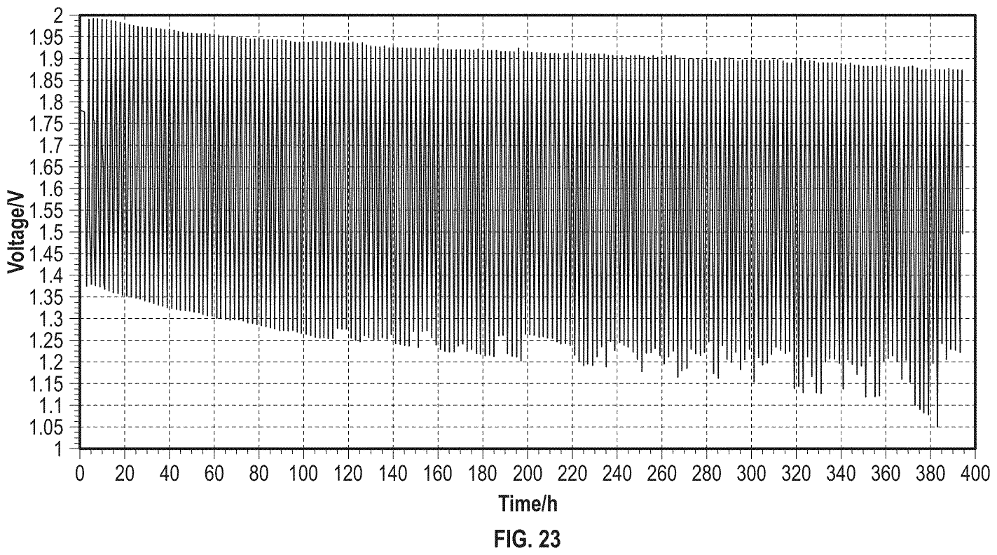

FIG. 23 is a voltage versus time plot of charging and discharging an example battery including matching ALD coated 25 um Zn anode with MnO2 cathode. The voltage shows a reasonable range between 1 V and 2V for aqueous Zn—MnO2 battery with confined operation capacity.

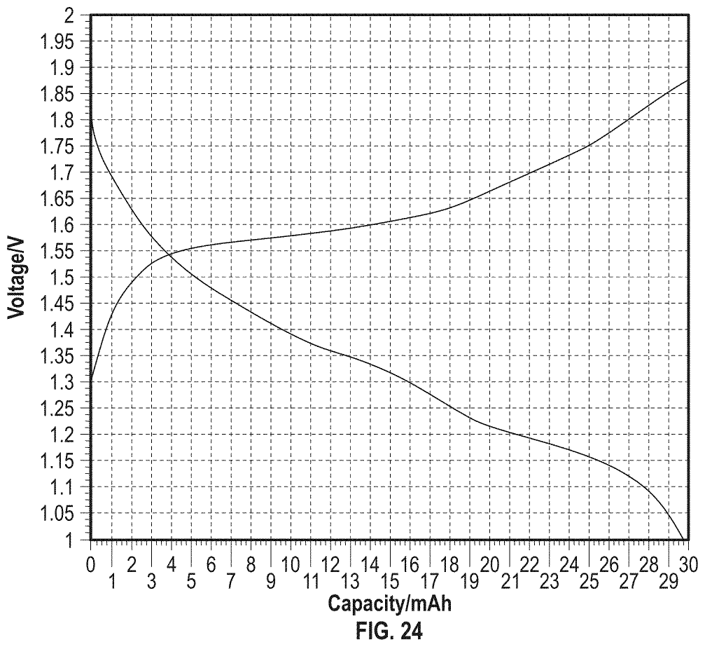

FIG. 24 is a voltage versus time plot of charging and discharging an example battery including matching Zn anode with MnO2 cathode, in which Zn is electrodeposited onto chemically etched Cu foil substrate in 0.1M H2SO4 acid. It shows constant lifetime of at least 200 cycles without sign of degradation at 1 C current rate. The lifetime is equal to more than 400 hours operation. The difference between charge capacity and discharge capacity is small that leads to higher than 99% efficiency. Voltage profile shows cycling between 1 V and 1.9 V. The result shows that through chemical pretreatment of current collector substrate before disposing Zn film is able to achieve high performance and durability.

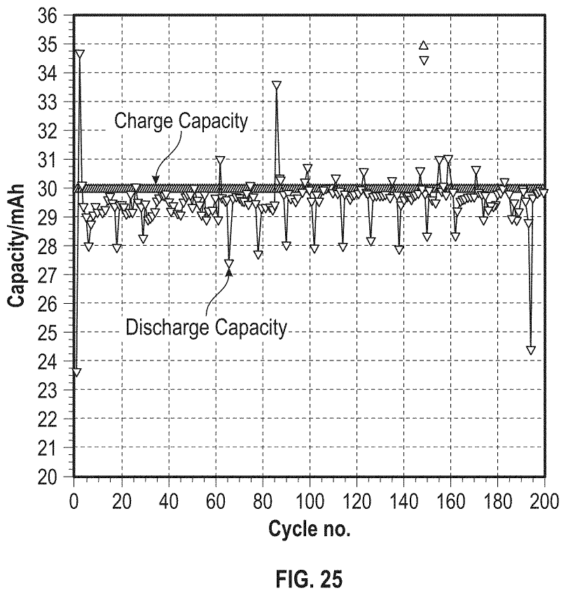

FIG. 25 is a plot of capacity versus cycles for the battery of FIG. 24.

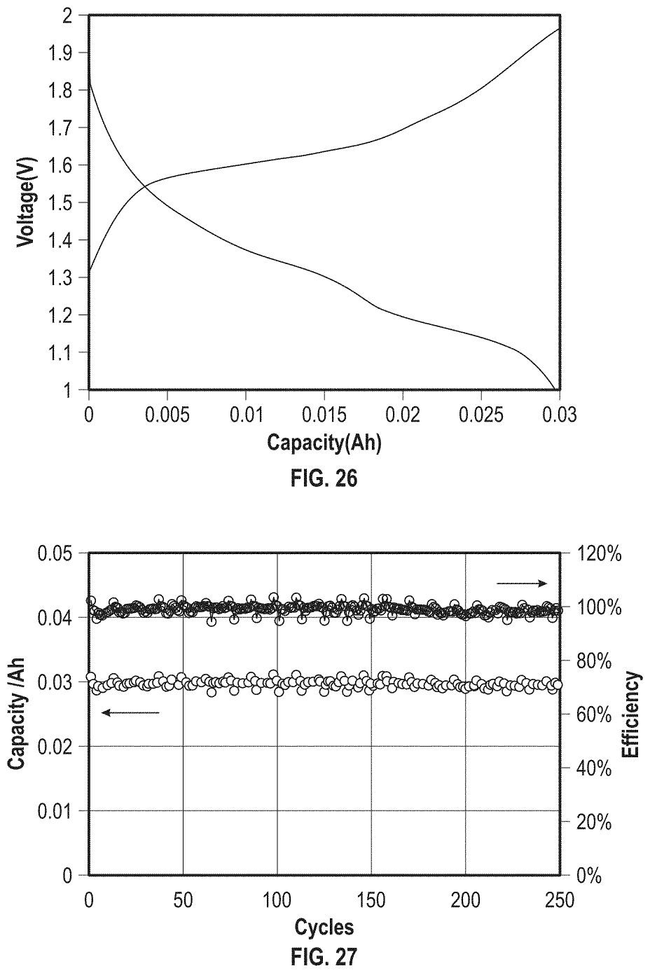

FIG. 26 is a voltage (V) versus capacity (Ah) plot for an example battery including matching Zn anode with MnO2 cathode, in which Zn is electrodeposited onto chemically etched Cu mesh substrate in 0.1M H2SO4 acid. It shows constant lifetime of at least 250 cycles with coulombic efficiency higher than 99% at 1 C current rate. The lifetime is equal to over 500 hours of operation. Voltage profile shows smooth cycling between 1 V and 1.9 V. The result shows that through chemical pretreatment of metal mesh current collector substrate before disposing Zn film is also able to achieve high performance and durability.

FIG. 27 is a plot of capacity (left) and efficiency (%) versus cycles for the battery of FIG. 26.

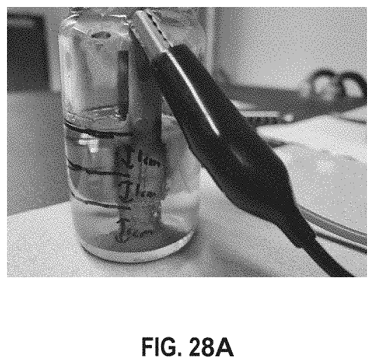

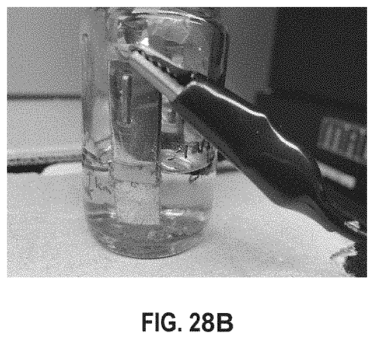

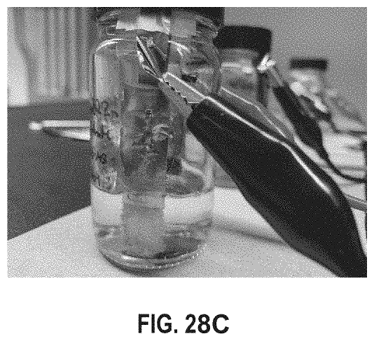

FIG. 28A is a picture of a Zn-based anode with an untreated stainless steel substrate after being tested though charge and discharge cycles. FIG. 28B is a picture of a Zn-based anode with an untreated titanium substrate after being tested though charge and discharge cycles. FIG. 28C is a picture of a Zn-based anode with an untreated copper substrate after being tested though charge and discharge cycles.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims. Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the elements that it introduces.

A number of examples have been described. Nevertheless, it will be understood that various modifications can be made. Accordingly, other implementations are within the scope of the following claims.

What is claimed is:

1. A composite anode for a zinc-based battery device, comprising:
a pretreated Zn layer with one or more first coating layers, where in the Zn layer comprises a Zn film;
a pretreated current collector substrate with one or more substrate coating layers;
wherein the pretreated Zn layer is pretreated by one or more of polishing, grinding, sanding, etching, and cleaning and the pretreated current collector substrate is pretreated by one or more of polishing, grinding, sanding, etching, and cleaning.

2. The composite battery anode for the zinc-based battery device of claim 2, wherein the pretreated Zn layer is pretreated by etching including by one or more of stirring, sonicating, and agitating in an acidic solution.

3. The composite battery anode for the zinc-based battery device of claim 3, wherein the acidic solution includes one or more of HCl, H2SO4, CH3COOH or HNO3 aqueous solutions with a concentration between 0.01 to 3 mol/L.

4. The composite battery anode for the zinc-based battery device of claim 1, wherein cleaning includes disposing the Zn layer or the substrate in a cleaning solution, including one or more of water, ethanol, isopropyl alcohol, acetone, and methanol.

5. The composite battery anode for the zinc-based battery device of claim 1, wherein a surface of the Zn layer is prepared using one or more of a drying under vacuum, drying with convection, and drying in an ambient atmosphere.

6. The composite battery anode for the zinc-based battery device of claim 1, wherein the Zn film includes one or more of a carbon coating, composite coating, polymer coating, metal oxide coating, metal coating, and/or surface alloying.

7. The composite battery anode for the zinc-based battery device of claim 1, wherein the coating layer on the Zn layer is applied by one or more of brush painting, spin coating, blade coating, dip-coating, electroplating, pulse electroplating, electrodeposition, constant voltage electrodeposition, constant current electrodeposition, pulse electrodeposition, cyclic voltammetric deposition, and electrophoretic deposition.

8. The composite battery anode for the zinc-based battery device of claim 1, wherein the coating layer is formed in-situ after assembling into a full battery cell by controlling voltage and current for electrodeposition, and the electrolyte is included with additives comprising of one or more of cetyltrimethylammonium bromide (CTAB), sodium dodecyl sulfate (SDS), polyethylene glycol 8000 (PEG), sodium sulfate, sodium hydroxide, sodium acetate, polypyrrole, polyaniline, polycarbonate, Poly(methyl methacrylate) (PMMA) and thiourea.

9. The composite battery anode for the zinc-based battery device of claim 1, wherein the first coating layer and second coating layer includes an alloy with one or more other metals selected from the group consisting of Cu, Li, In, Sn, Al, Ga, Ge, Ni, Mn, Co, Nb, Cr, V, Ti, Zr, Ag, Au, Pd, Pt, Si, Fe, carbon and their alloys.

10. The composite battery anode for the zinc-based battery device of claim 1, wherein one or more of the alloy with one or more other metals is formed by one or more of wet mixing, dry mixing, chemical treatment, and heat treatment.

11. The composite battery anode for the zinc-based battery device of claim 1, wherein the Zn film includes at least one additional deposition.

12. The composite battery anode for the zinc-based battery device of claim 11, wherein the additional deposition includes one or more of Cu, Li, In, Sn, Al, Ga, Ge, Ni, Mn, Co, Nb, Cr, V, Ti, Zr, Ag, Au, Pd, Pt, Si, Fe, carbon, and their alloys.

13. The composite battery anode for the zinc-based battery device of claim 11, wherein the deposition is performed by one or more of atomic layer deposition, chemical vapor deposition, physical vapor deposition, pulsed laser deposition, thermal evaporation, electrodeposition, and sputtering.

14. The composite battery anode for the zinc-based battery device of claim 11, wherein post thermal annealing is applied with temperature between 80° C. to 1500° C. under ambient, oxidized, or reduced environment such as argon, nitrogen, hydrogen and their mixture for between 0.1 hour to 48 hours.

15. The composite battery anode for the zinc-based battery device of claim 1, further comprising a current collector substrate is formed from one more materials selected from the group consisting of carbon paper, carbon felt, graphite felt, graphite foil, carbon cloth, conductive polymer membranes, metal mesh, metal plate, and metal foil; and wherein the metal of the metal mesh, the metal plate, and the metal foil is selected from the group consisting of copper, stainless steel, brass, stainless steel, nickel, zinc, aluminum, titanium, and their composites.

16. The composite battery anode for the zinc-based battery device of claim 16, wherein the current collector substrate is pretreated by one or more of washing, polishing, etching, doping, coating, and alloying.

17. The composite battery anode for the zinc-based battery device of claim 16, wherein the current collector substrate is coating in one or more coating layer materials selected from the group consisting of graphene, amorphous carbon, activated carbon, carbon fiber, carbon nanotubes, metal oxides, electrical conductive oxides, carbides, metal powders, metal fibers, and conductive or non-conductive polymers.

18. A composite battery anode for a Zn-based battery device, comprising:
a pretreated Zn anode layer comprising a composite of Zn powder, carbon powder, and a polymer binder, wherein the Zn anode layer is coated with one or more first coating layers; and
on a pretreated current collector substrate coated with one or more substrate coating layers; and
wherein the pretreated Zn layer is pretreated by one or more of polishing, grinding, sanding, etching, and cleaning and the pretreated current collector substrate is pretreated by one or more of polishing, grinding, sanding, etching, and cleaning.

19. The composite anode of claim 18, wherein the Zn powder size is between 10 nanometers and 100 micrometers.

20. The composite anode of claim 18, wherein the Zn powder is etched by an acidic solution, wherein the acidic solution includes one or more of HCl, H2SO4, CH3COOH at the concentration of between 0.001 mol/L to 10 mol/L.

21. The composite anode of claim 18, wherein the Zn powder is coated by one or more materials selected from the group consisting of a metal oxide, a metal, a carbonaceous material, and a polymer.

22. The composite anode of claim 21, wherein the Zn powder is coated by one or more metal oxides selected from the group consisting of titanium oxides, zirconium oxides, aluminum oxides, hafnium oxides, copper oxides, indium oxides, silicon oxides, tin oxides, silver oxides, vanadium oxides, chromium oxides, iron oxides, cobalt oxides, nickel oxides, manganese oxides, niobium oxides, molybdenum oxides, and germanium oxides.

23. The composite anode of claim 21, wherein the Zn powder is coated by one or more metal elements selected from the group consisting of Cu, In, Sn, Al, Ga, Ge, Ni, Mn, Co, Nb, Cr, V, Ti, Zr, Ag, Au, Pd, Pt, Si, and Fe by forming an alloy on the surface.

24. The composite anode of claim 21, wherein the Zn powder is coated by one or more carbon materials selected from the group consisting of amorphous carbon, graphite, natural graphite, synthetic graphite, activated graphite, conductive graphite, graphene, carbon nanotubes, hard carbon, and soft carbon.

25. The composite anode of claim 21, wherein the Zn powder is coated by one or more conductive polymers selected from the group consisting of polyaniline, polypyrrole, and polyvinylpyrrolidone.

26. The composite anode of claim 21, wherein the Zn powder is coated by one or more ion-selective materials selected from the group consisting of polyvinyl chloride, polyvinyl chloride-valinomycin, polyvinyl chloride-tridodecylamine, dibenzylamine, and octyldibenzylamine.

27. The composite anode of claim 21, wherein the Zn powder is coated by one or more of chemical coating method and/or a deposition method.

28. The composite anode of claim 18, wherein the carbonaceous material is selected from the group consisting of carbon black, acetylene black, conductive carbon, amorphous carbon, soft carbon, hard carbon, conductive graphite, activated graphite, natural graphite, artificial graphite, synthetic carbon, graphene, carbon fibers and carbon nanotubes.

29. The composite anode of claim 18, wherein the polymeric binder is selected from the group consisting of polypyrrole, polyaniline, poly(3,4-ethylenedioxythiophene), polyvinylidene fluoride, polytetrafluoroethylene, ethyl cellulose, styrene-butadiene rubber, nitrocellulose or carboxymethyl cellulose, and acrylate-type binders.

30. A method of making a composite anode for a zinc-based battery device, comprising:
providing an anode comprising a Zn layer disposed on a currently collector substrate;
pretreating an Zn layer by one or more of polishing, grinding, sanding, etching, and cleaning;
pretreating a current collector substrate by one or more of polishing, grinding, sanding, etching, and cleaning;
after pretreating the Zn layer, etching the Zn layer;
after etching the Zn layer, coating the Zn layer with one or more first coating layers, wherein the first coating layers comprise TiO2; and
coating the current collector substrate with at least one substrate coating layer.
